(19) United States
(12) Patent Application Publication
(10) Pub. No.: US 2019/0240936 A1
(43) Pub. Date: Aug. 8, 2019

(54) PATCH ASSEMBLY FOR TUBELESS TIRE

(71) Applicant: John W. Feiler, Orange, CT (US)

(72) Inventor: John W. Feiler, Orange, CT (US)

(21) Appl. No.: 15/887,615

(22) Filed: Feb. 2, 2018

(51) Int. Cl. B29C 73/14; B29C 73/12

(52) U.S. Cl. CPC B29C 73/14; B29C 73/12

(57) ABSTRACT

An apparatus for patching a tubeless tire includes a patch; a washer centrally located on the patch; a fastener extending from the washer; and a cap engageable with the fastener, whereby the patch can be mounted in a tear of a tubeless tire with the patch on an inside of the tear and the cap on the outside of the tear. The patch can be used to quickly repair a ruptured tubeless tire, for example of a mountain bike, without the need of adding a tire tube within the tire.

### BACKGROUND OF THE INVENTION

The invention relates to a patch assembly for repairing a tubeless tire, more specifically to a patch assembly for repairing a ruptured tire of a mountain bike in a fast and easy manner which does not interfere with the continued use of the tire.

Tires have been used for conveying vehicles and other machinery for numerous different purposes, and inflatable or pneumatic tires have been used for countless such applications. One issue with inflatable tires is that they can be punctured or ruptured, resulting in a flat tire which must be repaired or replaced.

Inflatable tires have been utilized which have an inner tube, wherein the tube holds the pressurized air or other gas, and the tire serves as protection for the tube and also for providing suitable traction, etc. An alternative to tires with tubes are tubeless tires, where the tire itself seals against a rim to hold the tire, and the tire itself contains the pressurized air or other gas.

One well utilized area for such tires is with mountain or trail bicycles, wherein the tire must be both rugged and also as light as possible. Because of the weight concern, tubeless tires have become quite desirable for use with mountain bicycles. However, riding on rough terrain and/or trails subjects such tires to extreme wear and, in some cases, the tires can become ruptured.

Known solutions for flat tires, particularly flat tubeless tires, include deploying an inner tube within the flat tire so that the outer tire no longer needs to contain the pressurized air or gas. However, this adds the weight of the tube to the wheel, and a decrease in tire performance, both of which are undesirable.

Another type of solution to punctured tubeless tires is one which is widely used with automobile tires, and involves a plug which is forced into a puncture, for example made by a nail or other such device. These types of repairs are not particularly well suited to tubeless tires such as those used with mountain bicycles, where the damage is more likely to be a rupture or tear than it is to be a clean puncture. With a rupture or tear, known plug-type repairs are not particularly reliable in sealing the tire.

In addition, mountain bicycles are typically used in competitions wherein riders compete against each other to be first to complete a course through rugged terrain. If a tear or rupture occurs during such a competition, attempts to repair the tire using either a tube or a plug is time-consuming, and will likely take too long for that rider to stay in the competition.

It is the focus of the present invention to address the above issues.

### SUMMARY OF THE INVENTION

In accordance with the invention, a patch assembly is provided for tubeless tires which addresses the above issues, allowing for rapid and reliable repair of a tubeless tire with a rupture or tear, without increasing the weight of the tire/wheel or otherwise decreasing the usefulness of the tire.

According to the invention, an apparatus for patching a tubeless tire is provided, which comprises: a patch; a washer centrally located on the patch; a fastener extending from the washer; and a cap engageable with the fastener, whereby the patch can be mounted in a tear of a tubeless tire with the patch on an inside of the tear and the cap on the outside of the tear.

In one aspect of the invention, the fastener can be a screw which is inserted from the inside, through the washer, the patch, the rupture in the tire, and then into the cap to secure the patch assembly within the rupture. Since a tubeless tire has adhesive already deployed within it to hold a seal with the wheel, the patch contacts the adhesive and is held against it be the tightened fastener and washer. Further, re-pressurizing the tire also adds the force of pressure to hold the patch in place over the rupture or tear from the inside, helping to ensure a gas-tight seal.

In another aspect of the invention, the fastener can be a “zip strip” or other type of mono-directional fastener wherein the cap is ratcheted down along the fastener until it is sufficiently tight, at which point excess fastener material can be removed. This embodiment is particularly well suited to use in a competition, as it allows for a rapid repair of the tire and return to riding. If a tear or rupture is experienced, the rider can remove one side of the tire from the wheel, position the patch over the rupture from the inside of the tire, with the fastener extending outwardly through the rupture or tear, and then secure the cap over the end of the fastener and tighten the cap until the patch assembly is sandwiching the tear, with the washer-supported patch on the inside, and the cap on the outside. The tire can then be re-pressurized, and the rider can immediately return to riding. For an experienced user, this can be done in only a few minutes.

In another aspect of the invention, the washer can be integrally formed with the patch. Further, the patch and washer can be movable along the fastener. With this embodiment, the patch assembly can be deployed from outside the tire, through the rupture, to even further speed the process of repairing the flat tire.

Other details, aspects and advantages of the invention will appear in the detailed description to follow.

### BRIEF DESCRIPTION OF THE DRAWINGS

A detailed description of preferred embodiments of the invention follows, with reference to the attached drawings, wherein:

FIG. 1 illustrates a typical tire for a mountain bicycle;

FIG. 2 illustrates a patch assembly according to the invention, assembled around a schematically illustrated tire;

FIG. 3 is a cross section through the assembly of FIG. 2, showing the components of the invention installed through a rupture in a tire;

FIG. 4 further illustrates details of the washer and patch components of the invention;

FIG. 5 further illustrates details of a cap component of the invention;

FIG. 6 further illustrates details of one embodiment of a fastener component of the invention;

FIG. 7 is a schematic illustration of a non-limiting further embodiment of the invention wherein the fastener is a zip strip or zip tie;

FIGS. 8 and 9 illustrate an alternative embodiment wherein the washer and patch are integrally formed; and

FIGS. 10-12 illustrate a further alternative embodiment of the invention useful for repairing a tire entirely from outside the tire.

### DETAILED DESCRIPTION

The invention relates to a patch assembly for a tubeless tire, and in one non-limiting environment, to a patch assembly for a tubeless tire for a mountain or trail bicycle.

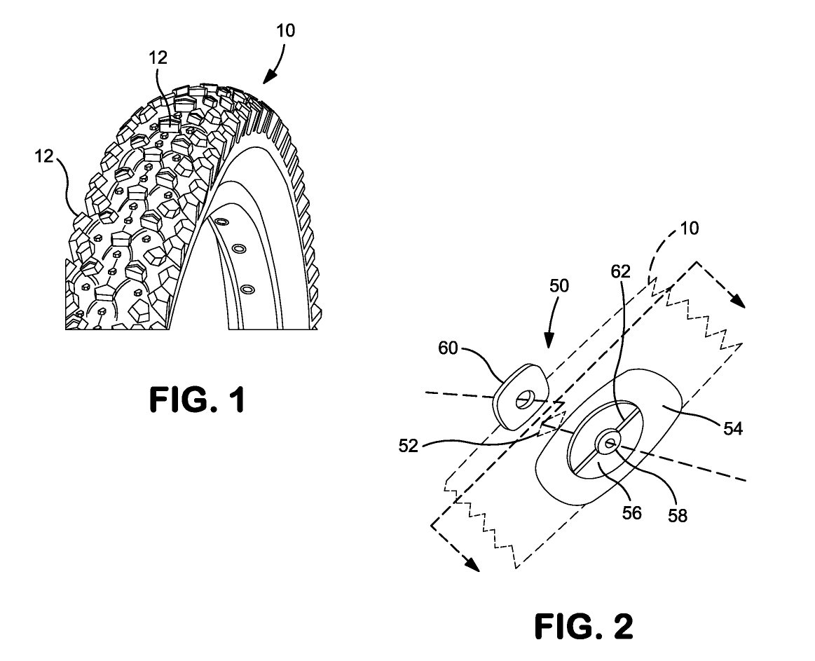

FIG. 1 illustrates a typical tire 10 for such a bicycle, and it can be seen the tire 10 typically has a series of knobs 12 extending outwardly from the tire surface to enhance traction and grip of the tire for rough riding conditions. The present invention is directed to a patch assembly for use in rapidly and reliably repairing a tear or rupture in such a tire, without requiring addition of a tube or other device which adds weight, and without reducing the useful life of the tire.

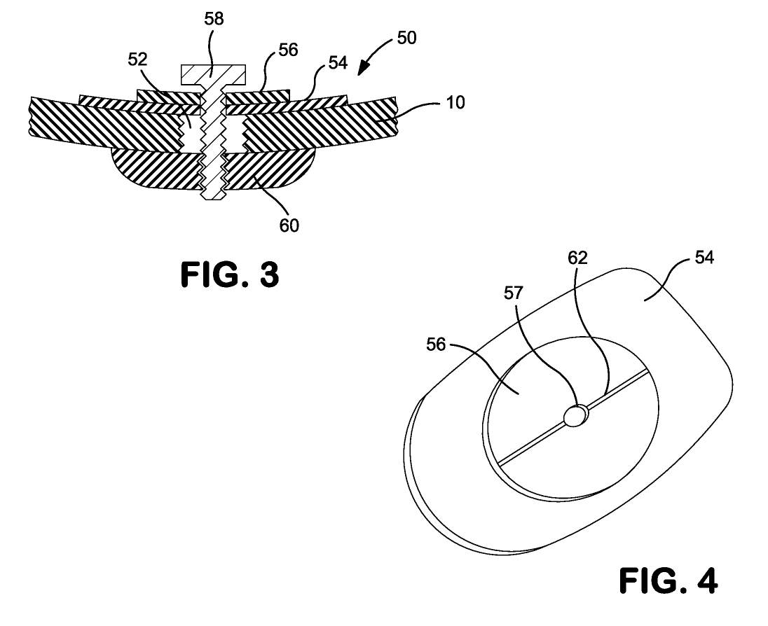

Referring to FIGS. 2 and 3, a patch assembly 50 is illustrated according to the invention for use in sealing a tear or rupture 52 (FIG. 3) in tire 10. As shown, assembly 50 includes a patch 54, a washer 56, a fastener 58 and a cap 60, all of which will be further described below.

Assembly 50 can be used to repair a hole or a tear, for example up to ½″ in size, in a tubeless mountain bike tire. Assembly 50 can be used to repair such a tear on either the tread or sidewall of the tire.

Assembly 50 works as a modified inside and outside nut and bolt attachment, and allows a user or rider of the bike to quickly repair a damaged tire while on the trail and preserve the life of the tire with no change in tire performance.

Inner components of assembly 50 include washer 56 and patch 54. Washer 56 can be, for example, a slightly cupped washer, for example of about one inch size, with a hole for the fastener, for example a hole of about ⅛″ in size. Patch 54 can be a rubber sheet, and is preferably flexible and durable. Patch 54 can be substantially round, and could have a diameter, for example, of about 1⅝ inches. Patch 54 can advantageously be made of material similar to that of which bicycle tubes are made, for example, butyl rubber or latex, or combinations of these materials as non-limiting examples. The material can advantageously have a thickness of between 0.5 mm and 1.5 mm, preferably about 1.0 mm.

Patch 54 and washer 56 can be attached to each other, for example with contact cement, if desired. This attachment helps to keep both components in proper position during installation and use.

As mentioned above, washer 56 is slightly cupped such that it has a convex surface facing the patch 54. This convex surface can be oriented during installation in a tire such that convex surface is curved around an axis drawn tangent to a direction of rotation of the tire. Thus, the convex surface is to conform to the inner curve of the tire.

Washer 56 can be provided with a marking or other indicia to help a user properly orient the convex surface relative to the direction of rotation of the tire. In one non-limiting embodiment, washer 56 can have a line 62 which can be oriented along the direction of rotation of the tire. Alternatively, the line could be an arrow or have a small arrow head to help visually indicate to the user a proper orientation of the assembly relative to direction of rotation of the tire.

Cap 60 can be any suitable cap which can engage with fastener 58 and be sufficiently durable to withstand further riding on the repaired tire in continued rough conditions. In one non-limiting example, fastener 58 can be an M4-70×12 mm metric cap screw with a 3 mm head, and having a lock tight bead on a beveled tip for insertion through the damaged tire. A longer fastener 58 can also be provided, for example 16 mm (or longer), as this may be needed for a deep tread pattern.

Cap 60 can be a one piece solid metal cap, for example with a matching M4-70 fine thread and a lock washer. Cap 60 is also preferably curved to be concave toward the outer surface of the tire when installed, and toward the inner components of the assembly when installed.

Cap 60 is not designed to mimic the typical tire knob, rather it is designed to be a lower profile to avoid shear forces to which the tire will be exposed during acceleration and deceleration.

Turning to FIG. 4, a washer 56 and patch 54 are further illustrated. Patch 54 can have any suitable shape, for example round, oval, rectangular or other shape. Further, patch 54 can be provided out of larger size material and cut down to match a rupture of a particular size, if desired. Cap 60 and washer 56 hold the assembly in place through the washer, and patch 54 functions to seal the site of the tear of rupture. In this regard, the patch is held in place initially by cap 60 and washer 54, and then is further held in place by the adhesive already in place inside the tire, and pressure in the tire once the tire is re-inflated.

Patch 54 should also be provided either in advance, or in preparation for use, with a hole corresponding to the approximate center of the patch, so that the fastener can be passed therethrough during installation.

Still referring to FIG. 4, washer 56 should also have an opening or hole 57 through which fastener 58 is inserted in preparation of the patch assembly for installation.

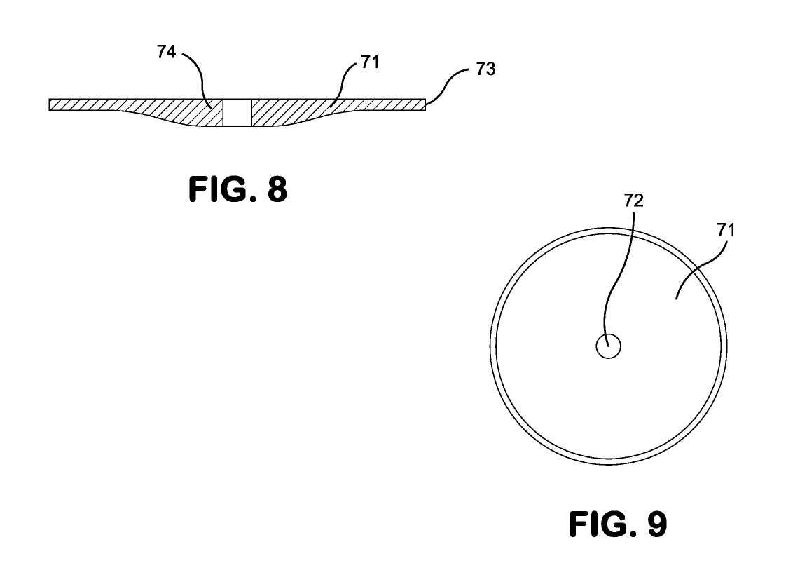

Alternatively, the fastener and washer could be provided as a single component or article of manufacture, as in the embodiment of FIGS. 8 and 9 discussed below.

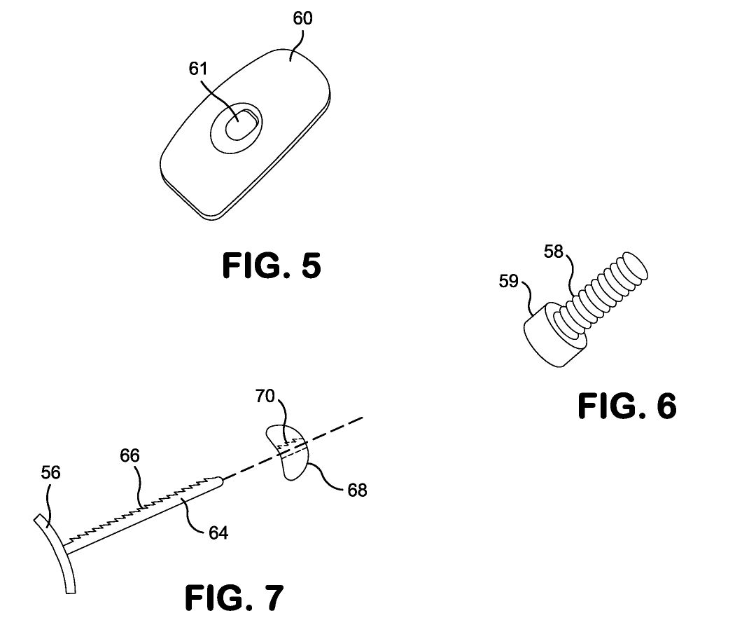

FIG. 5 is a further illustration of cap 60 according to the invention, and shows cap 60 having a rounded outer surface. This surface does not need to specifically match the knobs of the tire, but the thickness of the structure does help to provide stability to the fastener and overall assembly during use, such that the patch assembly durably holds in place, sealing the rupture, during remaining lifetime use of the tire.

Cap 60 also preferably has a central opening 61 with inner facing threads to engage with fastener 58. Rotation of fastener 58 from the inside, for example using a suitable tool such as an Allen wrench or the like, engages fastener 58 with opening 61 and tightens washer 56 and cap 60 onto opposite sides of the tire, around the rupture, to seal the rupture with patch 54 as desired.

FIG. 6 shows a typical fastener 58 for use in this embodiment of the invention. Fastener 58 has a head portion 59 which is sized sufficiently large to hold with stability against washer 56 when the patch assembly is installed in a tire. Further, the threads of fastener 58 are typically a fine pitch thread, as mentioned above, and serve to firmly engage with the threads in the opening 61 of cap 60. As schematically illustrated in FIG. 2, head portion 59 of fastener 58 has a suitable structure to engage it with a typical tool for rotation and firm engagement with the cap. In one particularly suitable configuration, the structure is a socket for engaging with an Allen wrench. This is desirable because an Allen wrench is a tool which is routinely carried by riders. Of course, fastener 58 could have any of numerous other structures for engaging, for example with a conventional flat or Philips head screw driver, or the like.

Patch assembly 50 according to the invention can be used as follows.

When a flat tubeless tire is discovered, with the bike first turned upside down, the tire should be taken off of one side of the rim, for example using a nylon tire lever. One side of the tire needs to be removed only enough to expose the inside of the damaged tire. Next, fastener 58 can be inserted through the washer 56 from the concave side, and then be inserted through the patch 54. Fastener 58 can then be inserted through the tear in tire 10 so that patch 54 faces the rubber of the tire at an inside surface of the tire.

Next, the line 62 or other marking on washer 56 can be aligned with direction of the rotation of the tire. The cap 60 can then be attached to the fastener, and preferably only hand-tightened. While still loose, the cap 60 can be lined up to fit between the tire knobs and fastener 58 can then be snugly tightened against an outside surface of the tire, for example using a 3 mm Allen wrench.

If the tear is next to a knob, patch assembly 50 might not fit as perfectly as in other instances, but either way a longer bolt or fastener can be used and the repaired tire will hold long enough to finish a competition or otherwise complete a day's activities. Once back at home the rubber knob may be shaved down to the level of the tire to assure a tight fit of cap 60.

In an alternative embodiment, the fastener and cap can be provided as a “zip tie” system. This repair can be faster and would only require a small knife blade to cut off the excess tie.

FIG. 7 shows a fastener 64 in accordance with this embodiment, wherein the fastener is a long flexible strip of durable material having ratchets 66 or one-way teeth. The cap 68 for this embodiment can have a similar outer shape to cap 60 of the embodiment of FIGS. 2, 3 and 5. However, in this instance, instead of having inner threads to engage a threaded fastener, cap 68 has a pawl or other structure or structures 70 for engaging with teeth 66 of fastener 64 such that cap 68 can be moved along fastener 64 toward washer 56, but is held against movement away from washer 56.

Fastener 64 can be provided as a nylon round zip tie type of attachment and is preferably anchored to the convex side of washer 56 as shown. Fastener 64 can be a separate component from washer 56 in which case it would be threaded through washer 56 and patch 54 before being installed through a rupture in a tire.

Cap 68, as set forth above, is the “female” mate to the zip tie attachment, and in one non-limiting example could measure 16 mm×8 mm and have a similar concave shape where it is to meet the outer surface of the tire.

Use of the embodiment of FIG. 7 is similar in concept to that of the embodiment of FIGS. 2, 3 and 5. Specifically, the first step would be to remove half of the tire from the rim, for example using a nylon “tire lever”, enough to expose the inside of the damaged tire. Next, the nylon zip tie or fastener 64 is inserted through patch 54 and then, from the inside of the tire, through the rupture or tear in the tire. Next, line 62 should be aligned with direction of rotation of the tire. This properly orients the convex surface of washer 56 with the inner curve of the tire. Then, cap 68 can be positioned onto fastener 64 and firmly presses to contact with the tire, and the zip tie structure of fastener 64 and cap 68 hold cap 68 in this position. Excess length of fastener 64 can then be snipped off and removed, and the tire re-inflated.

It should be appreciated that the patch assembly of the present invention is a significant improvement over known repair systems. As mentioned above, tubeless mountain bike tires require the use of a tire sealant that primarily seals the seam between the tire and the rim. Typical sealants include products such as Stans, Slime and Orange seal, among others. These products also advertise as being able to seal a hole up to a quarter of an inch in size. However, the capacity of a sealant as a tire repair is limited. In cases where the sealant is unable to seal the hole or tear, the rider would typically use a tube for the duration of the life of the tire. The present invention allows for quick repair of a tear up to a half an inch in size, and restores the useful life of the tire without negatively affecting the performance of the tire.

In contrast, conventionally a flat tire would have to be removed from the frame of the bike, the sealant drained, and a tube would be inserted and re-inflated. The tire would then have to be remounted to the bike. This is a time consuming process and also results in additional weight and primarily reduces the performance of the tire. On the other hand, the patch assembly according to the present invention does not require removal of the tire from the frame of the bike, and the repair can therefore be done on the trail. Further, the process can be completed in as little as 3 minutes and it will last the life of the tire and allow the rider to experience the benefits of staying “tubeless.” Thus, the patch assembly of the present invention provides both the immediate benefit of staying in a competition, and the long term benefit of maintaining the useful life of a tire without reduction in performance.

FIGS. 8 and 9 illustrate an alternative structure of the washer and patch portion of the present invention. In this embodiment, the patch and washer are formed integrally such that a patch portion 71 blends into a thicker and more rigid washer portion 74. Patch portion 71 extends to an outer edge 73 which defines a circumference sufficient to cover the tear or rupture in a tire from the inside, and can be dimensioned similarly to the embodiments described above. Further, an opening 72 can be provided through the center of the thickened or washer portion 74, for receiving the fastener in similar manner to the embodiments discussed above.

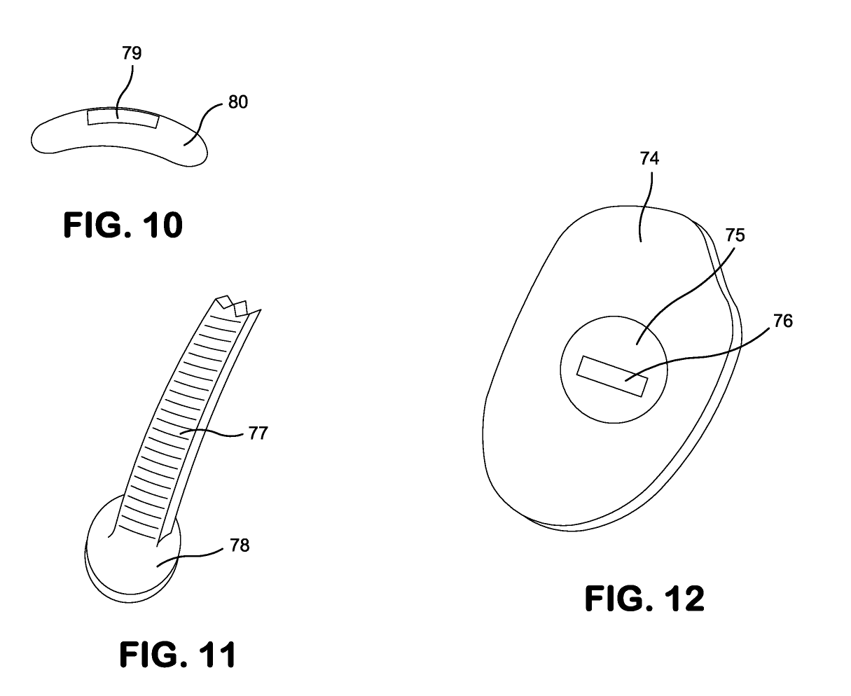

FIGS. 10-12 illustrate still another embodiment of the invention, wherein a zip tie 77 (FIG. 11) having a head portion 78 which extends radially outwardly beyond the elongate body of the tip tie is used with a patch 74 and washer 75 (FIG. 12) which can slide along the sip tie 77. In this embodiment, the cap 80 (FIG. 10) can be provided having a slot 79 for sliding along and engaging zip tie 77. This configuration of the invention can be advantageously used to repair a tire from the outside, which can be particularly advantageous in situations where it is difficult or time-consuming to remove the tire from the wheel.

One particularly suitable example of a need for this embodiment is with tubeless tires that are frequently now fitted with engineered foam tire inserts that mount inside a mountain bike tire and fit tight against the rim. The inserts lessen the volume of air inside the tire, absorb impacts against the rims, lessen vibration, and add lateral stability. However, tires with inserts are virtually impossible to repair on a trail, because removing the tire requires extra effort and support. The configuration of FIGS. 10-12 is well-suited to this situation because the patch assembly can be deployed within the tire entirely from outside the tire, without needing to remove the tire. This structure is similar in concept to how a toggle bolt works for drywall applications.

Specifically, with the bike turned upside down, the tear in the tire should first be inspected, and may need to be enlarged to a size of approximately ⅜″ in length. The bottom 78 of the zip tie is then fed through the tear into the tire, pushing the bottom 78 as far into the tire as possible. Then, the patch and washer assembly 74, 75 are slid over the zip tie 77 by way of slot 76 in washer 75. Patch and washer 74, 75 can be manipulated such that the rubber of the patch is folded around washer 75, which should be approximately ¼″ in size, such that the combination can pass through the rupture or tear. Once the combination is inside the tire, patch 74 can be unfolded from around washer 75 and deployed next to the inside surface of the rupture or tear. Pulling up on zip tie 77 will seat washer 75 and patch 74 against the inside surface of the tire, at the rupture. Cap 80 is then positioned onto zip tie 77 and pressed down tight against the outer surface of the tire, with zip tie 77 pulled upwardly as well, to secure patch 74 and washer 75 against the rupture from the inside, and cap 80 against the rupture from the outside. Excess zip tie can then be trimmed away and the tire re-inflated.

It is possible that a knob may be in the way of cap 80. If this is the case, the knob should be trimmed away to make room for the cap. The only tool needed for this repair is a small sharp knife such as a pocket knife, and the entire repair can be completed without removing the tire from the wheel. Thus, this configuration and method are particularly well-suited to mountain bike tires which are fitted with inserts.

It should be appreciated that although the present description is given in terms of specific embodiments of the invention, alterations and modifications would be apparent to those of skill in the art, and such alterations and modifications are considered to be within the broad scope of the invention as defined herein.

1. A patch assembly for patching a tubeless tire, comprising:
a patch;
a washer centrally located on the patch;
a fastener extending from the washer; and
a cap engageable with the fastener, whereby the patch can be mounted in a tear of a tubeless tire with the patch on an inside of the tear and the cap on the outside of the tear.

2. The apparatus of claim 1, wherein the patch is a substantially flat flexible member.

3. The apparatus of claim 2, wherein the patch is made of a material selected from the group consisting of butyl rubber, latex and combinations thereof.

4. The apparatus of claim 2, wherein the patch has a thickness of between 0.5 mm and 1.5 mm.

5. The apparatus of claim 1, wherein the washer is more rigid than the patch.

6. The apparatus of claim 1, wherein the washer is smaller in diameter than the patch.

7. The apparatus of claim 1, wherein the washer has a marking indicating a direction for proper installation with respect to a rotation direction of the tire.

8. The apparatus of claim 7, wherein the washer has a patch facing side and an opposite side, and wherein the marking is on the opposite side.

9. The apparatus of claim 5, wherein the washer has a convex surface facing toward the cap.

10. The apparatus of claim 9, wherein the washer has a marking indicating a direction for proper installation with respect to a rotation direction of the tire, and wherein the convex surface is curved around an axis tangent to the direction of rotation.

11. The apparatus of claim 1, wherein the fastener is a screw and the cap has threads sized to engage with the screw.

12. The apparatus of claim 1, wherein the fastener is integrally formed with the washer.

13. The apparatus of claim 1, wherein the washer is integrally formed with the patch.

14. The apparatus of claim 1, wherein the fastener comprises a zip tie and the cap is slidably engageable with the zip tie.

15. The apparatus of claim 1, wherein the patch and the washer are movable along the fastener.

16. A method for patching a ruptured tubeless tire, comprising the steps of:
placing a patch and a washer over a tear in a tubeless tire on an inside surface of the tire with a fastener extending from the washer and through the tear;
attaching a cap to the fastener in contact with an outside surface of the tire so as to hold the patch in place over the inside surface of the tire at the tear; and
inflating the tire.

17. The method of claim 16, wherein the placing step comprises inserting the patch and the washer from outside the tire, through the tear and into the tire such that the patch and washer extend over the tear on the inside surface of the tire.
